(19) United States
(12) Patent Application Publication
(10) Pub. No.: US 2001/0036182 A1
(43) Pub. Date: Nov. 1, 2001

(54) Method and apparatus for selecting and delivering internet based advertising

(76) Inventor: Frank Addante, Los Angeles, CA (US)

Correspondence Address: CHRISTIE, PARKER & HALE, LLP, 350 WEST COLORADO BOULEVARD, SUITE 500, PASADENA, CA, 91105, US

(21) Appl. No.: 09/757,389

(22) Filed: Jan. 8, 2001

Related U.S. Application Data
(60) Provisional application No. 60/175,113, filed on Jan. 6, 2000.

(51) Int. Cl. H04L 12/56; H04L 12/28

(52) U.S. Cl. 370/389; 370/401

(57) ABSTRACT

A network based advertising selection system for selecting and delivering adverting content to a user computer. A content server receives a request for content from a user computer and responds by transmitting content pages with space for one or more advertisements and a referral command to a direct connect server. The user computer follows the referral command and requests an advertisement from a direct connect server. The direct connect server receives advertising selection criteria and generates and transmits a request for an advertisement to a advertisement selection server. The creative selection server identifies of one or more advertisements and sends the location of the advertisement to the user computer.

### CROSS-REFERENCE TO RELATED APPLICATIONS

This application is based on provisional patent application Ser. No. 60/175,113, filed Jan. 6, 2000.

### FIELD OF THE INVENTION

This invention relates to the field of digital advertising via computer networks, and more particularly, to a method and system used to dynamically select and display advertisement to users via a computer network, such as the Internet.

### BACKGROUND OF THE INVENTION

With the growth and commercialization of the Internet a method and apparatus for selecting and delivering Internet based advertisements has much utility. Much of the content on the Internet is located on the World Wide Web, the often graphical portion of the Internet which has become the defacto location for publishing information.

In prior systems users connected to a serverwhich contained content which was of interest to the user. The content server also contained one or more advertisements, known in the art as a “creative.” Creatives may include one or more photographs, sound clips, movie clips, or some other form of communicating a message, but are typically graphical in nature and therefore are larger in size than mere text. Creatives were served to the users directly from the content server. This system had an advantage in that only one content server was necessary thereby reducing hardware costs. However, for busy content sites one content server was not desirable. As the number of users accessing the content server increased the load on the content server increased as well. The added load of serving creatives often bogged down the content server. Content providers who wished to reap the benefits of placing advertisements on their site either had to manually place the ads themselves by editing their web pages, or allow a third party, such as an advertising company, access to their content server.

As HTML (hypertext markup language), HTTP (hypertext transfer protocol) and other Internet related protocols advanced content servers were able to supply the user the requested content (typically HTML code), and then redirect the users to retrieve the creatives from a different URL (universal resource locator), typically on a different server. HTML is the programing language for publishing hypertext on the World Wide Web, and Hypertext Transfer Protocol (HTTP), an application-level protocol for distributed, collaborative, hypermedia information systems. This redirection allowed for load balancing between several servers and subsequently faster performance for the user. Additional, advances now allow for creatives to contain click-thru HTMLcode in addition to the message or graphic. Click-thru code automatically redirects the user to a new URL when the user clicks on the creative.

As advertising on the Internet further matured methods for counting the number of times a particular creative was viewed were developed. Additional tools have also been developed which enabled creatives to be targeted only at users who are most likely to be interested the creative, or by those users who fit a given profile. These tools base their decision on several factors including information provided by a user, and by cookies stored on the user's computer, and other targeting information.

### SUMMARY OF THE INVENTION

The present invention provides a system and method for rapidly and efficiently serving electronic advertisements to users via a computer network. In certain embodiments according to the present invention, when a user transmits a request to a content server for content, the content server returns the requested content and one or more redirect commands which instruct the user to retrieve one or more creatives from a different server. The user follows the redirect instruction and requests the creative from the second server. The second server is merely a front-end server which gathers information about the user and information about which content server and page the user is currently viewing and then communicates this information directly to an creative selection server. The creative selection server selects the actual creative, based on the information communicated to it by the front-end server, and based on a number of other pre-programmed factors.

The creative selection server communicates the complete location of the selected creative back to be front-end server, which in turn sends the user a redirect to the location of the selected creative. The user follows the redirect instruction and requests the creative from the creative server. The creative server sends the creative and any additional click-thru code to the user, who incorporates the creative into the content from the content server. While this series of redirection and the like is seemingly complex, it is quite transparent to the user.

### DESCRIPTION OF THE DRAWINGS

FIG. 1 is a block diagram of one embodiment of the invention.

FIG. 2 is a block diagram of a second embodiment of the invention.

### DETAILED DESCRIPTION OF THE INVENTION

In the following embodiments of the invention, common reference numerals are used to represent the same components. If the features of an embodiment are incorporated into a single system, these components can be shared and perform all the functions of the described embodiments.

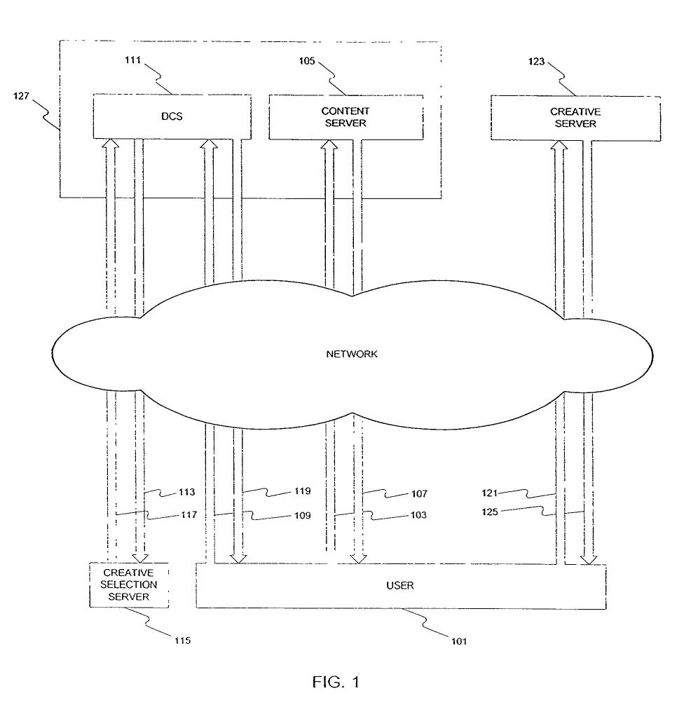

FIG. 1. shows a typical block diagram of one embodiment of the invention. A user 101 connected to a network, such as the Internet, typically uses some form of retrieval tool like a web browser such as Netscape Navigator, or the like, to communicate with web servers connected to the network. Netscape and Navigator are trademarks of Netscape Communications Corporation. Communications between various nodes (users and content servers) on the Internet takes place using the TCP/IP communications protocol, and at higher layer HTTP and HTML communications protocols. A detailed description of the IP communications protocol is discussed in Internetworking with TCP/IP, 3rd ed., Douglas Comer, Prentice Hall, 1995, which is fully incorporated herein by reference. The user begins the communication by transmitting a request for content 103 to a content server 105. Of course the user does not directly perform the specified function, rather the user instructs a software program like a web the browser to do so; hereafter for the sake of clarity the term “user” will be used to identify the computer host operated by the user, and its attendant hardware and software. This communication is typically in the form of an HTML request for a URL. The content server returns the requested content 107, typically a web page containing HTML code, and also includes one or more redirection commands 107 which redirects the user to the DCS server 111. Typically the redirection command 107 is an HTML <href>, or an HTTP redirect command which contains a fully qualified URL. HTML and HTTP are well-known in the art, and comprehensive documentation about HTML, HTTP and related topics are disclosed on the World Wide Web Consortium's web site, <http://www.w3.org/>, which is fully incorporated herein by reference.

The user 101 follows the redirect command received from the content server 105 and issues an new HTML request to the DCS server 111. The DCS server 111 is designed and programed to work in conjunction with the content server 105, and both are co-located at the same site 127. The content server's redirection command 107 contains a URL to a specific location on the DCS server 111 corresponding to the location the user is browsing on the content server. Accordingly, the DCS server 111 “knows” the location of the content page the user is currently viewing without the need for an additional message from the content server 105.

The DCS server 111 receives additional information about the user from various methods such as cookies, the user's IP address, and other user specified parameters, and uses this information to generate a profile of the user. The DCS server 111 may be programed to generate a more exhaustive user profile, or to create a reduced profile. In an alternative embodiment the DCS server 111 may generate a user profile which does not contain any actual information about the user, including the user's IP address, for use in guarding the user's privacy. The DCS server 111, would instead, map the user's IP address from the correct IP address to a non-public IP address such as 1.1.1.1, or the like, thereby protecting the user's privacy. The DCS server 111 would reverse map the non-public IP address to the user's correct IP address to facilitate further communications with the user's computer from the DCS server 111. This technique can be employed to mask other user attributes in addition to the user's IP address.

The DCS server 111 then generates a request for a creative 113 message which includes the generated user profile and the current content page and transmits the request for a creative 113 to the Creative selection server 115. The DCS server 111 may transmit the request for a creative 113 to the Creative selection server 115 via the network. A direct connection may also be used. The DCS server 111 may also be programed to only send a sample of the user requests, such as every one in three requests, to the Creative selection server 115, and to cache and reuse a selected creative, thereby reducing network congestion and improving system performance.

By using the DCS server 111 to generate the request for a creative 113 system performance can be maximized by eliminating certain processes and transmissions. For example, certain features may be enabled or disabled, such as the use of a keyword search feature (i.e. “boating” is often used to select creatives of interests to boat enthusiasts), or the transmission of the type of Internet web browser the user is operating. Additionally, since all requests for a creative 113 are between the DCS server 111 and the Creative selection server 115 a standard transmission format may be used eliminating various communications overhead in the transmission. One such example of overhead is the tracking and transmission of various categories of creatives by implantinga “C” code for the category in the request (i.e. code such as “C=12” in implanted in each request). In the present invention the use of a category code may be shortened to only “12” as the Creative selection server 115 will know the meaning of the element “12” when received in a specific location of the request for a creative 113. An additional benefit of using a DCS server 111 to generate the request for a creative 113 is that the DCS server is able to cache typical user profiles with high accuracy, which greatly reduces the load on the processor.

The co-location of the DCS server 111 with the Content server 105 at the same site 127 provides two benefits: First, the user already has performed any needed domain name to IP address queries and the route to the Content server has already been discovered and is cached, thereby reducing any network delay in following the redirection command 107 to a different site. Second, the content provider may determine the level of service provided to its users as the network connection to the DCS server 111 is the same as to content server 105. As the request for a creative 113 message is very small and the load on the Creative selection server 115 has been reduced, the network connection to the site 127 sets the level of service provided. Of course, network communication is only as fast as the slowest connection in the network, and this typically is the user's connection.

The Creative selection server 115 receives the request for a creative 113 from the DCS server 111. Using the information contained in the request with other information contained in its database of creatives, the Creative selection server 115 selects an appropriate creative for this user's session with the content server 105. The Creative selection server 115 then communicates the fully qualified URL for the selected creative to DCS server 117. The DCS server 111 receives the fully qualified URL from the Creative selection server 115 and generates an appropriate HTML <href> or an HTTP redirect command which is sent to the user 101 in response to the users request. In the event that the Creative selection server 115 does not respond to the DCS server 111 request for the creative 113 within a specified time the DCS server 111 will send the user a fail safe creative, or a fail safe <href> or redirect command.

The user 101 follows the redirect command received from the DCS server 111 and issues a new HTML request to the creative server 123, requesting the creative. The creative server 123 responds to the user's request 121 and transmits the creative 125 to the user 101. The user 101 then incorporates the creative into the original content provided by the content server 105. The original HTML code supplied by the content server 105 often specifies various attributes of the creative, such as its location on the page, its size, and the like.

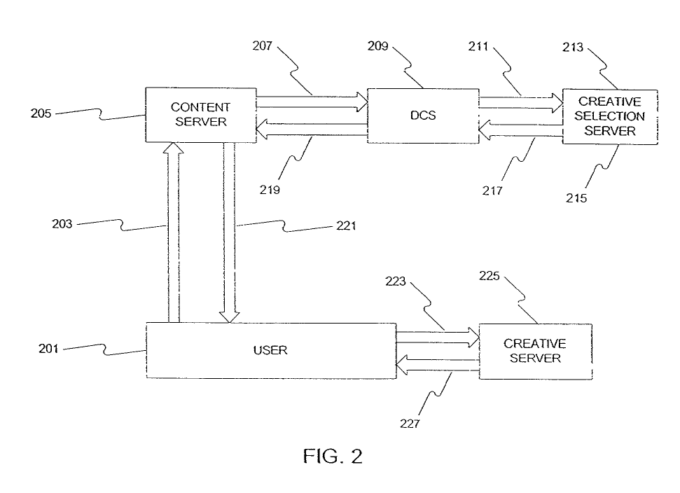

FIG. 2. shows a typical block diagram of a second embodiment of the invention. A user 201 connected to a network, such as the Internet, typically uses some form of retrieval tool like a web browser such as Netscape, or the like, to communicate with web servers connected to the network. The user begins the communication by transmitting a request for content 203 to a content server 205. This communication is typically in the form of an HTML request for a URL. The content server 205 also receives additional information about the user from various methods such as cookies, the user's IP address, and other user specific parameters. After receiving the user's request 203 the content server 205 forwards the users information and the web page the user requested to the DCS server 209 via communications path to 207. The DCS server 209 is programed to work in conjunction with the content server 205, and may be physically located at the same hosting site or located somewhere else on the network. The DCS server 209 compiles all the pertinent information mentioned above and generates a request for a creative 211 to the Creative selection server 213. The request for a creative 211 may contain the complete set of compiled information, or a subset as necessary for the Creative selection server 213 to select an appropriate creative. In an alternative embodiment the DCS server 209 may generate a request which does not contain any actual information about the user, including the user's IP address, for use in guarding the user's privacy. The DCS server 209, would instead, map the user's IP address from the correct IP address to a non-public IP address such as 1.1.1.1, or the like, thereby protecting the user's privacy. The DCS server 209 would reverse map the non-public IP address to the user's correct IP address to facilitate further communications with the user's computer from the DCS server 209. This technique can be employed to mask other user attributes in addition to the user's IP address.

The Creative selection server 213 receives the request for a creative 211 from the DCS server 209. Using the information contained in the request with other information contained in its database of creatives, the Creative selection server 213 selects an appropriate creative for this user's session with the content server 205. The Creative selection server 213 then communicates the fully qualified URL for the selected creative to DCS server 217. The DCS server 209 receives the fully qualified URL from the Creative selection server 213 and generates an appropriate HTML <href> or an HTTP redirect command which is sent to the content server 205 for incorporation into the final HTML code sent to the user 201 in response to the users request for content 203. In the event that the Creative selection server 213 does not respond to the DCS server 209 request for the creative 211 within a specified time the DCS server 209 will send the user a fail safe creative, or a fail safe <href>or redirect command.

The user 201 follows the redirect command received from the content server 205 and issues a new HTML request 223 to the creative server 225, requesting the creative. The creative server 225 responds to the user's request 223 and transmits the creative 227 to the user 201. The user 201 then incorporates the creative into the original content provided by the content server 205. The original HTML code supplied by the content server 205 specified the various attributes of the creative including such items as location on the page, size, and the like.

1. In a network system comprising a public network, a creative selection server, a content server, and a user computer that requests content pages over the public network and receives content pages with space for one or more embedded creatives from the content server: a server system comprising
a direct connect server connected to the content server by other than the public network, wherein the direct connect server receives creative selection criteria from the content server, generates a request for creative message as a function of the creative selection criteria; transmits the request for creative message to the creative selection server; receives an identification of one or more creatives from the creative selection server; and sends the identification of one or more creatives to the content server.

2. The request for creative message of claim 1 further defined as a function of a stored profile.

3. The request for creative message of claim 1 further defined as a function of the IP address of the user computer.

4. The request for creative message of claim 1 further defined as a function of whether or not the user computer has previously connected to the content server.

5. The request for creative message of claim 1 further defined as a function of the domain name of the user computer.

6. The request for creative message of claim 1 further defined as a function of a search term entered by the user computer.

7. The request for creative message of claim 1 further defined as a function of IP address of the content server.

8. The request for creative message of claim 1 further defined as a function of mapping the IP address of the user computer, but not including data from which the actual IP address can be derived.

9. The request for creative message of claim 1 further defined as a function of whether or not the user computer has previously connected to the direct connect server.

10. The request for creative message of claim 1 further defined as a function of the domain name of the content server.

11. The request for creative message of claim 1 further defined as a function of a meta tag on the content server.

12. The direct connect server of claim 1 further comprising a lookup table for storing category codes for use in generating a request for creative message.

13. In a network system comprising a public network, a creative selection server connected to the public network, a content server, and a user computer that requests content pages over the public network and receives content pages and redirect commands for one or more creatives from the content server: a server system comprising
a direct connect server connected to public network separately from the creative selection server, wherein the direct connect server receives creative selection criteria from the user computer,
generates a request for creative message as a function of the creative selection criteria;
transmits the request for creative message to the creative selection server; and
receives an identification of one or more creatives from the creative selection server and sends the identification of the one or more creatives to the user computer.

14. The request for creative message of claim 13 further defined as a function of a stored profile.

15. The request for creative message of claim 13 further defined as a function of mapping the IP address of the user computer, but not including data from which the actual IP address can be derived.

16. The request for creative message of claim 13 further defined as a function of the IP address of the user computer.

17. The request for creative message of claim 13 further defined as a function of whether or not the user computer has previously connected to the content server.

18. The request for creative message of claim 13 further defined as a function of the domain name of the user computer.

19. The request for creative message of claim 13 further defined as a function of a search term entered by the user computer.

20. The request for creative message of claim 13 further defined as a function of IP address of the content server.

21. The request for creative message of claim 13 further defined as a function of whether or not the user computer has previously connected to the direct connect server.

22. The request for creative message of claim 13 further defined as a function of the domain name of the content server.

23. The request for creative message of claim 13 further defined as a function of a meta tag on the content server.

24. The direct connect server of claim 13 further comprising a lookup table for storing category codes for use in generating a request for creative message.
